(19) United States
(12) Patent Application Publication
(10) Pub. No.: US 2010/0234983 A1
(43) Pub. Date: Sep. 16, 2010

(54) Control system for granular material transport system

(75) Inventors: Enzo Gesuita, Santa Maria di Sala (VE) (IT); Riccardo Ronzone, Santa Maria di Sala (VE) (IT)

Correspondence Address: Themis Law, 7660 Fay Ave Ste H-535, La Jolla, CA, 92037, US

(73) Assignee: PIOVAN SpA, Santa Maria di Sala (VE) (IT)

(21) Appl. No.: 12/403,212

(22) Filed: Mar. 12, 2009

(51) Int. Cl. G05B 19/18; G06F 19/00; G05B 19/44

(52) U.S. Cl. 700/217; 700/305

(57) ABSTRACT

A control system for a pneumatic transport system of granular material, which includes a plurality of containers, is configured to manage the filling cycle of each container automatically by monitoring the weight of the transported material continuously, and by optionally monitoring the state of the granular material, for example temperature and humidity of the granular material. The information generated by the control system is provided to a centralized management system, which may be operated entirely or partially through radio signals transmitted by wireless technology.

### FIELD OF THE INVENTION

The present invention relates to a control system for a pneumatic transport system for granular materials. More particularly, the present invention relates to a control system for a transport system of granular materials that operates under positive or negative pressures, which cause the granular material to be transferred from one or more central storage points to one or more local storage points situated in different locations, or to one or more points of use such as dehumidification hoppers, mixing systems, processing machines, or other pieces of equipment.

### BACKGROUND OF THE INVENTION

A pneumatic transport system for granular materials essentially includes a unit that generates a positive or negative air flow along one or more pipes connecting one or more granule storage points, sometimes identified as sources in the trade, to one or more destination points, sometimes identified as containers in the trade. A number of other devices may also be included within the transport system, for example, sorting and selection systems, valves for duct cleaning, mixing valves, etc.

Throughout the present description and in the appended claims, reference will be made to “granular materials” or “granules.” A person skilled in the art will appreciate that such terms are meant to include also materials having structures similar to granules, for example, chips, re-milled materials, or powdery materials.

The air flow, whether of positive or negative pressure, moves the granules from the sources to the containers, where the material becomes available for transport to points of use situated downstream, for example another storage unit, a dehumidification hopper, a mixing unit, a processing machine or other types of equipment. An intermediate buffer hopper collecting of the granular material may be provided between the containers and the final point of use, allowing the downstream point of use to be supplied with a desired amount of material for a predetermined period of time even with the upstream container is empty or is undergoing a filling cycle.

The control of the entire system is typically entrusted to a centralized logic control unit, which exchanges information with peripheral units, such as containers, pressure/vacuum units, etc., through a serial or similar connection. The serial connection line must be installed throughout the plant in order to link all components of the system.

The prior art generally teaches two alternative system for starting up and for performing a container filling cycle.

The first system in the prior art may be defined as a “time-limited filling system,” in which the container filling cycle is triggered by a sensor that signals that the container is empty or that a material inside a hopper located below the container has fallen below a predetermined threshold.

The duration of the filling process is typically set by trial and error by an operator that uses a switchboard and that attempts to achieve an optimum filling cycle, such to avoid an excessively long loading cycle and a clogging of the ducts conveying the granules.

Therefore, the evaluation of the duration of the filling process is inherently limited by its essentially manual nature and a series of empirical tests must be performed before a fine tuning of the process may be achieved, with the consequent waste of time and material.

Further, the parameters of this system are not necessarily constant over time, both because of structural aging of the system (particularly due to clogging of the filters of the transport unit or of a filter separating the air from the granules inside the container) and because of possible variations in granule flowability caused, for example, by different lots of material or variations in environmental conditions.

Still further, transport time must be adjusted manually for each change in the type of transported material or when a partial filling is desired, that is, when the containers are not to be filled completely. This may occur, for example, when the amount of material requested downstream of the container is decreased, or when the same container must feed at the same time two users having different processing capacities. If load exceeds consumption, the material may be retained in the container/buffer hopper system, and if the granule had been previously dehumidified or simply heated, too much humidity may be reabsorbed or an excessive cool down may occur.

In the second system in the prior art, a start-up of the filling cycle is performed similarly to the first system, but the filling cycle is terminated when the granules inside the container reach a predetermined threshold, which may be detected by a sensor.

This second system offers the advantages of eliminating or reducing the time and material required for setting up the system and of reducing dependence from the level of maintenance of the system, but does not resolve the inability of the system to change the amount of fill material without resetting the system, because the sensors are typically placed in fixed positions or can only detect a predetermined level of material that has been set manually by the operator.

Another limitation of the systems in the prior art is the low reliability of the level sensors and the high costs of the sensors, especially for heated granules. Sensitivity of the sensors also tends to be highly affected by the type and color of the granule to be detected, and reference values of these sensors often change over time, requiring periodic re-settings.

The logic control of the transport system is generally based on one of two architectures.

A first method of control is sometimes referred to as “centralized logic method.” In this architecture, the central processing unit generally collects all inbound information from the peripheral units, processes such information, and finally broadcasts commands to all system components. As a result, the system components behave as “slaves,” that is, are typically configured only to send information to the central processing unit and to receive commands from it.

A second architecture is sometimes referred to as “distributed logic method.” In this architecture, the central processing unit still collects information, processes it and broadcasts commands to all system components. The system components, however, can execute certain local functions without being managed by the central processing unit, for example, can interrupt an ongoing filling cycle when the local sensor detects that the material has already reached a threshold or when the time elapsed for the filling cycle exceeds a predetermined value.

In both cases, every system component connected to the serial communication network requires a unique physical address, which is set up manually by the operator during installation, for example, using dip-switches.

A limitation common to all the systems in the prior art is the complexity of the required wiring. In fact, in both the centralized logic and in the distributed logic solutions, installation of the required communication wiring causes significant hardware and labor costs.

Further, installation time, allocation of addresses and debugging of the system, as well as the time needed to fix possible connection and/or addressing errors cause additional costs that affect the profitability of the system.

Still further, wiring and installation require spaces that significantly affect machine layout and the position of the granule containers feeding downstream machines.

### SUMMARY OF THE INVENTION

It is an object of the present invention to provide a control system for a pneumatic transport system of granular material that includes a plurality of containers.

It is another object of the invention to provide an automated management system for filling containers disposed within a transport system of granular materials, thereby reducing to a minimum or eliminating the manual operations involved in setting up and configuring the system before start-up and also the manual processing required to modify operating parameters according to local conditions or to the type of transported material when the system is already operating.

A transport system constructed according to the principles of the present invention may include a wireless communication network instead of or together with a traditional wired network for interconnecting the individual components of the system.

The high degree of automation of the control system according to the invention is achieved by continuously monitoring the weight of a container during the filling cycle, such to determine when the filling must start and when it must be interrupted once a pre-established amount has been reached.

More particularly, a system according to the invention provides for monitoring a container through a series of statistical parameters related to effective filling time, weight of the transported material and, consequently, flow rate of the incoming material. In the event that a filling cycle in progress has one or more parameters, such as time and/or other parameters, that fall outside of the values contained in saved historical data, the system can warn a supervision system, the centralized control system, and/or an operator connected to a communication network (wired or wireless) through portable terminals. If, for example, the time required for the filling cycle and measured by timers is significantly longer than a statistical value processed by the system, an alarm can be generated to warn of possible problems along a transport duct or of lack of material in one of the sources.

In addition, the system is self-teaching with regard to the consumption of material per unit of time, or the flow rate of the outgoing material released by each granule container.

Measurements can be executed locally with weighing instruments connected to a control card coupled to each container, or remotely with the centralized control unit and/or with a supervision system, which can obtain data regarding weights at pre-established intervals for each node or container interconnected within the network. In the event that a simultaneous filling of two or more containers is required, instead of following, for example, a FIFO-type logic (First In First Out) to manage the first emptied container, filling priority may be given to the container with a higher historical flow rate.

This configuration makes it possible to determine whether a request for material from a user (the outbound material flow rate) is slowing down and thus intervene by reducing container load amounts, so to maintain a proper temperature and degree of humidity in the granules.

Likewise, filling amounts may be managed if, by gathering data about the state of the granule (such as temperature and humidity) through suitable sensors properly installed in the container, a possible degradation of the material (such as excessive cooling, humidity reabsorption, etc.) is detected.

By using a system according to the invention, material consumption may be determined with precision, allowing the storage of work data, the forecasting of consumption and the installation of alarms to monitor the material remaining in the sources, for example when the source is an external silo, the refilling of which requires reserving a tank truck well in advance.

The amount of the transported material may be managed by equipping the containers with one or more weighing instruments, and additionally with a set of sensors to detect or measure humidity, temperature or other parameters. All these instruments provide the management system with sufficient information to generate system archives, alarms, forecasts and information on the state of the system.

The new control system for managing a plurality of granule containers may use wireless technology for communicating between the central processing unit and the peripheral units or containers based on a protocol that can automatically recognize each unit upon connecting with the communication network. Moreover, the wireless protocol allows the automatic allocation of a unique address for each device connected with the communication network.

A wireless network technology according to the invention may include “self-healing” functions in the event of temporary or permanent failures of local control cards coupled to the containers.

The use of a wireless network further allows access to the network with portable or similar devices having wireless network interfaces which, once connected to the control network, enable an operator not only to collect and configure the containers or nodes of the network in the immediate vicinity but also to perform such operations for any remote container or node included in the network.

A wireless network generates a significant reduction in system costs with respect to a granule transport system that is based on a wired communication network and provides a number of advantages that include:

speed of installation of the system because there is no longer the need to physically lay network cables;

lower system costs because there are no network cables;

lower installation costs because the positioning of network cables imposes a significant limitation in the layout of machines and granule container systems feeding those machines; and

elimination of incorrect configurations caused by typical connection errors of cabled networks, such as network cables incorrectly coupled to the connectors, a mistaken positioning of electrical conductors in the network cables, possible disconnections and accidental cut-offs of cables.

### BRIEF DESCRIPTION OF THE DRAWINGS

These drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a diagram illustration of an exemplary pneumatic granule transport system based on using a negative pressure.

FIG. 2 is a diagram illustration of a connection topology between the various elements of the system of FIG. 1.

FIG. 3 is a diagram illustration of the loading cycle of a container controlled by a weight sensor, beginning with the container in an empty state (FIG. 3a) and ending with the container in a loaded state (FIG. 3b).

FIG. 4 is a diagram illustration of the container of FIGS. 3a and 3b equipped with a weight sensor and in the state, in which loading start-up is initiated by a traditional level sensor located in the receiver (FIG. 4a) or in the hopper underneath (FIG. 4b).

FIG. 5 is a diagram illustration of some possible node connection topologies that are typical of a wireless communication network.

### DETAILED DESCRIPTION OF EMBODIMENTS OF THE INVENTION

Detailed descriptions of embodiments of the invention are provided herein. It should be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

The present invention relates to a control system for equipment that transports granular material pneumatically and that stores the granular material. A system configured according to the principles of the present invention includes a highly automated management system for loading a plurality of containers and reduces to a minimum or entirely eliminates manual settings and configurations during start-up, as well as the steps required to modify operating parameters when conditions or types of materials to be transported change.

A control system according to the present invention may employ a wireless communication network instead of a traditional wired network for interconnecting the individual containers or nodes.

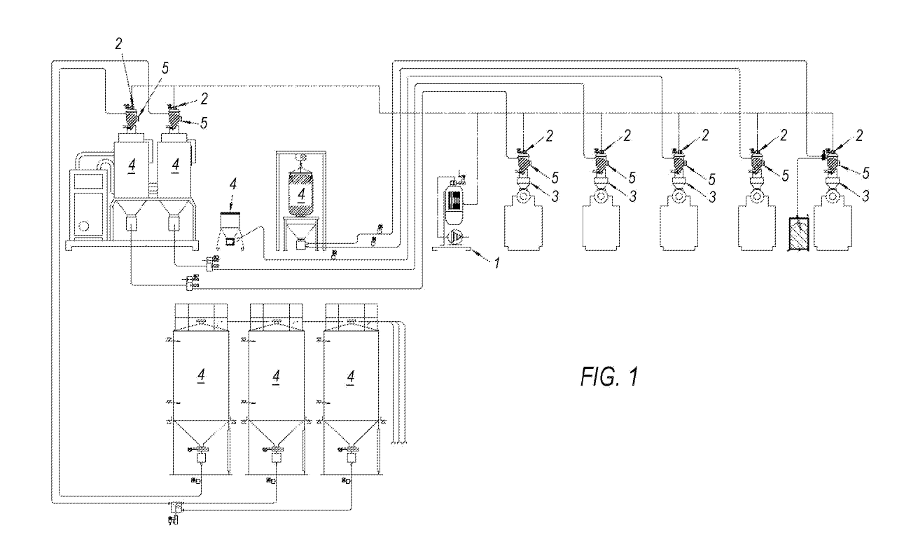

For the sake of simplicity, the following description relates to pneumatic transport equipment based on negative pressure, which is illustrated in FIG. 1 as including a vacuum generating unit 1 and a plurality of granule containers 2 installed over a buffer hopper 3. A person skilled in the art will appreciate that the following description may be extended to pneumatic transport systems operating with positive pressures or to more complex systems that may include, among other things, multiple vacuum/pressure generating units and sorting/selection systems.

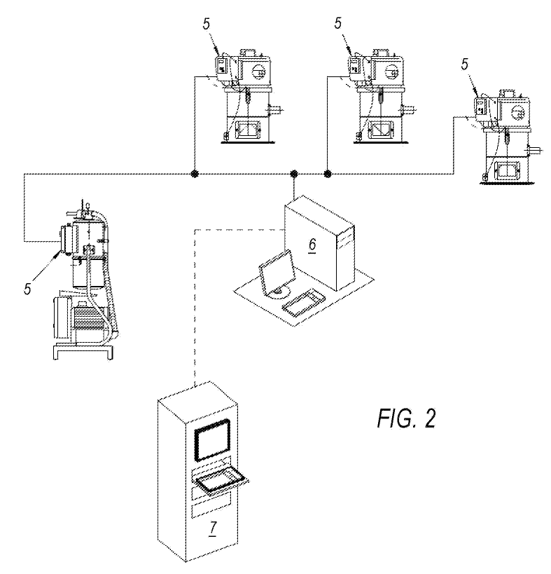

Moreover, transport equipment will be described herein, which is controlled by a “distributed logic” system (FIG. 2) that includes a central control unit or central processing unit (CPU) 6 configured to collect information and to coordinate, process and transmit operating commands, and that also includes a number of peripheral units 5 configured to provide information to CPU 6, to execute commands received from CPU 6 and to independently undertake procedures and actions at the local level.

A person skilled in the art will recognize that the control system described herein is applicable also to pneumatic conveying systems and plants that are controlled through a “completely centralized logic” system. Hybrid solutions are possible, in which control is centralized for certain aspects, governed mostly by a central control unit, and decentralized for other aspects, in which a part of the control is delegated to local controller 5, which may be a microprocessor card.

The high degree of automation of the transport system of the present invention is achieved by continuously monitoring the weight of every granule container, which, once the tare weight is recorded, determines material weight inside each container and, consequently, an evaluation of the amount of granular material that has been transported.

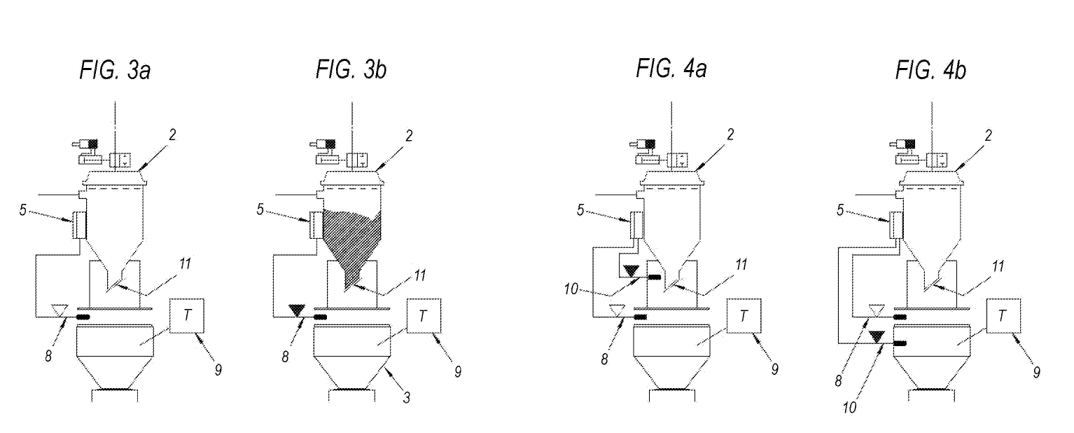

FIG. 3 illustrates a possible system for monitoring the weight of container 2 that includes a weighing instrument 8 installed under container 2. In other embodiments, any weighing instrument may be placed in different positions with regard to container 2. In on embodiment, weighing instrument 8 is integrated with local controller 5 coupled to container 2 and may include a suitable weight sensor, for example, a load cell connected to local controller 5.

Thus, load measurement may be performed either locally through a control card which is coupled to granule container 5 and to which one or more weighing units are connected, or remotely through centralized controller 6, which is configured to acquire weight data at predetermined time intervals by interrogating local controllers 5 coupled to individual nodes or containers 2 and interconnected within a network.

Every granule container 2 or the respective buffer hopper 3 may additionally be equipped with a plurality of sensors 9 for detecting or measuring temperature, humidity or other parameters, as described in greater detail below.

Real time information on the weight of the granular material inside container 2 may be processed by the control system, in its local 5 or central 6 unit, firstly to determine when container 2 is empty (FIG. 3a) and thus needs to be refilled. Alternatively, as shown in FIG. 4, the start-up of the refilling cycle may occur through a sensor 10 signaling that granular material is absent in container 2 (FIG. 4a) or in buffer hopper 3 below it (FIG. 4b).

In general, the amount of granular material provided during a refilling cycle may be determined by one or more control algorithms.

The filling and control situations illustrated in FIGS. 3 and 4 specifically concern a granule container 2 having a buffer hopper 3 installed upstream of a processing machine. As will be apparent to a person skilled in the art, those situations may also refer to other applications of granule containers 2.

Once the filling process of container 2 has begun, weight information is provided in real time and is used to determine the moment when the filling cycle must be interrupted because a maximum level has been reached. Related data may be employed in several ways, two of which are described hereinafter.

In a first method of determining duration of a fill cycle, the filling is “time-limited,” but, differently from the prior art, filling duration is not set manually by the operator but instead is calculated by the control system on the basis of a statistical processing of weights and durations of the previous filling cycles.

In a second method of determining duration of a fill cycle, the filling is interrupted as soon as the weight of the material inside the container reaches a predetermined value (FIG. 3b).

Statistically processed historical data on the weight of every filling of container 2 and on the time required to complete such filling is used by the control system, whether local 5 or central 6, to determine an average time limit, within which the filling cycle must be completed and, consequently, an average rate of material inflow rate to receiving container 2. In the event, for example, that the filling cycle in progress lasts longer that the statistically processed average time limit value, and by a percentage larger than a predetermined tolerance value, an alarm alerts of possible problems in the transport duct, of an irregular fill due to the defective closure of the discharge flap 11, and/or of lack of material in one of the sources.

If receiving container 2 is not filled within the time that has been predetermined based on average reloading time, local controller 5 coupled to receiving container 2 can independently decide to extend the filling time to add the missing amount of material. This extension of the filling time, identified also herein as extra time, is a supplemental period of time added to the predetermined time.

The statistical processing of historical data on the weight of every fill, the time necessary to complete the fill and the interval of time between fills may be used by the control system, either local 5 or central 6, to estimate with sufficient precision the consumption of material per the unit of time or flow rate of outbound material from each granule container 2.

In the event that the simultaneous filling of two or more containers 2 is required, instead of following a FIFO-type logic (First In First Out) to manage the first emptied container, filling priority may be given to the container with a statistically higher outbound flow rate.

Moreover, a system according to the present invention is configured to determine whether demand of material from the point of use is slowing down, if, for example, the time elapsed between fills is increasing with respect to the values between preceding fills. In an embodiment of the invention, the system may decrease the weight limit set point, thereby reducing the refill amount, in order to preserve its desired temperature and dew point values.

The control system may also intervene on the fill amount if, by gathering data on the state of the granule, e.g. temperature and humidity, through suitable sensors, e.g. temperature and dew point, installed in suitable positions 9, a degradation of the granules such as excessive cooling, humidity reabsorption, etc, is detected.

As shown in FIG. 2, central unit 6 of a control system according to the invention may be connected to a supervision or business management system 7 through a suitable communication network, either wired (e.g. Ethernet) or wireless (e.g. Wi-Fi).

The statistical processing of information related to weight, duration of each fill cycle and time intervals between fill cycles provides for a precise determination of consumption of material through the transport system over time, the creation of historical work archives, the generation of consumption forecasts, and the positioning of alarms for restoring material in the initial sources. In accordance with the configuration illustrated in FIG. 2, this type of information is provided by centralized control unit 6 to business management system 7 that will put it to the most appropriately use as planned by the user. For example, purchase orders for re-stocking consumed material may be automatically issued, especially when the source is an external silo, the filling of which requires reserving a tank truck well in advance.

As shown, a plurality of granule containers 2 that are provided as components of a transport system may be controlled through a centralized or decentralized control architecture. Either architecture is implemented through a communication network that transmits commands and coordinates container refilling operations, the interchange of information within the network, and/or the collection of data detected by the plurality of local controllers 5. As an alternative to a traditional wired network, the present invention provides for a wireless communication network interconnecting the granule receivers, each of which constitutes a node of the network.

The advantages of a wireless communication network with respect to a wired communication network include:

lower system costs because there are no network cables;

lower installation costs because there is no positioning of network cables;

speed of installation of the system, because network cables no longer need to be physically installed; and

elimination of incorrect configurations due to typical connection errors of cabled networks, such as network cables incorrectly coupled to the connectors, a mistaken positioning of the electrical conductors in the network cables, possible disconnections, and/or accidental cut-offs of cables.

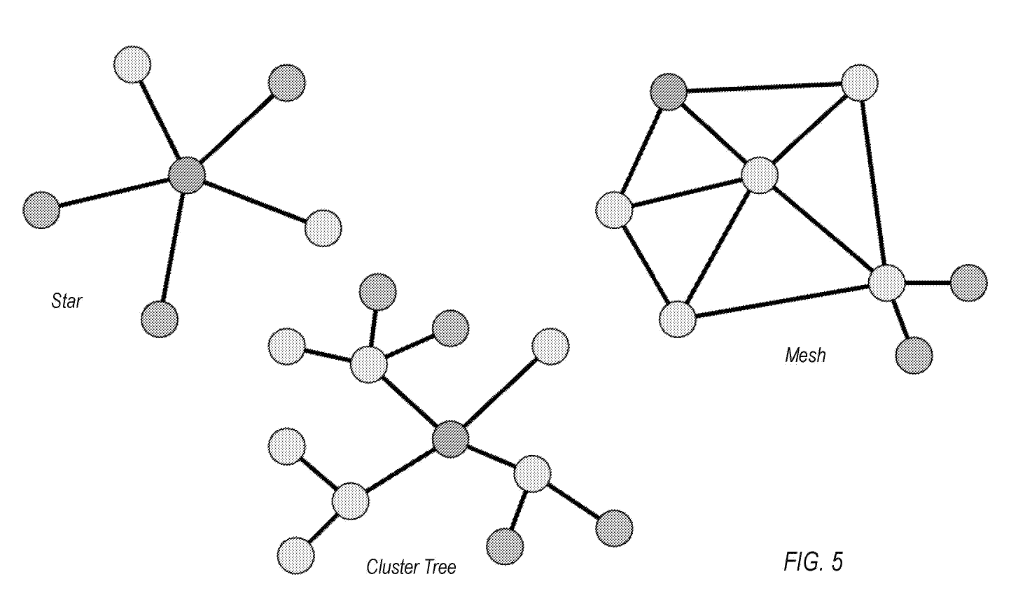

A feature of the wireless communication network employed in the present invention is that the interconnection topology of the nodes may be configured dynamically. As a persons skilled in telecommunications networks will appreciate, there are many possible connection topologies between nodes (e.g. Mesh Network, Cluster Tree Network, etc., an exemplary topology being shown in FIG. 5) and different possible types of networks (e.g. ad-hoc network, WLAN wireless local area network, WPAN wireless personal area network, etc.). Wireless communication networks, by not employing a wired physical layer, allow nodes to be reconfigured “on the fly,” that is, different connection topologies may be implemented without acting on the communication hardware. Such intrinsic automatism of the network protocol is employed in an embodiment of the present invention to adapt most favorably to the wireless interconnection of the transmitter-receivers coupled to the granule containers, for example, by using an ad-hoc network architecture. Such ad-hoc network architecture supports asynchronous mutual communications between the wireless nodes of which it is formed. Therefore each node of the network can communicate with every other node without an a priori definition of the interconnection topology between the nodes.

In an embodiment of the present invention, the nodes of the wireless communication network are configured automatically, that is, the operator does not have to provide a unique address for each electronic card in the system (e.g. set up the dip-switches on the local controllers of the granule containers). In this embodiment, the wireless protocol has typical functionalities, for example, uses a DHCP (Dynamic Host Configuration Protocol), which provides for the automatic allocation of a unique address for every device in the communication network.

Local controller 5 coupled to granule container 2 is equipped with hardware and related interface software that implements a suitable communication protocol for the wireless network. Such interface enables the local controller to exchange data, commands and information with any other node of the network (whether a receiver, a central controller, and/or one or more control/programming and/or supervision systems) without burdening the local controller coupled the container with the control and management of the wireless network.

Access to the wireless network is controlled and managed by interface hardware, which generally includes a network processor that manages all the parameters and processes related to the reception and transmission of information, for example, address allocation of the network node, routing of messages between different network nodes, verification whether the data received is correct and whether data have been received and transmitted in case of error, implementation of network “self-healing” strategies in the event of failure of one or more nodes, etc.

Such self-healing function is provided in the wireless communication network protocol and provides for a continuing operation of the system when one or more nodes are not functioning due to temporary or permanent failures or due to maintenance of the granule containers, without requiring a manual intervention to define a new network configuration that excludes the missing nodes.

In addition, the wireless network enables an operator to use portable, palm-sized, mobile or similar devices equipped with wireless network interfaces for supervising, programming and/or collecting data without implementing procedures and connections typical of wired systems.

In general, a pneumatic transport system for granular materials may extend across large areas as is typical in industrial installations. Operators may need to know the status or modify the settings of a particular granule container 2, which is included in the network, or conduct a diagnosis of local controller 5 coupled to container 2. With a hard wired system, this is achieved by connecting an interface or control device, such as a palm-sized device, directly to local controller 5 of granule container 2 or with a user interface of central controller 6. In both situations, this operation is not easy because, in the first case, the operator must access the granule container physically, sometimes in an elevated position, for the wired connection of the palm device to local controller 5 to take place, while, in the second case, the operator must physically access remote central controller 6.

Instead, by using a wireless network configured according to the principles of the present invention, diagnosis, configuration and data collection are made possible by equipping the operator with a palm-sized or similar device that has a wireless network interface. Such device becomes part of the wireless control network of the granule container system and allows the operator not only to collect and configure the network containers or nodes in his immediate vicinity but also to perform those operations for any remote receiver or node pertaining to the network.

While the invention has been described in connection with a number of embodiments, it is not intended to limit the scope of the invention to the particular forms set forth, but on the contrary, it is intended to cover such alternatives, modifications, variations and equivalents as may be included within the scope of the invention.

Therefore, with reference to the preceding description and the attached drawings, the following claims are set forth.

What is claimed is:

1. A control system for a pneumatic transport system of a granular material, the pneumatic transport system including a plurality of containers, the control system comprising:
a plurality of local control units each operatively coupled to a respective container;
a central control unit operatively coupled to the plurality of local control units, wherein the central control unit or one or more of the local control units exchange information and issue operating commands to at least one of the local control units, wherein the information comprises control or operating information including instructions which cause the at least one of the local control units to answer by providing information in return and/or by starting one or more procedures at a local level;
a communication network operatively connecting the central control unit with the local control units; and
a plurality of weighing instruments, one or more of the weighing instruments being operatively coupled to the respective container and measuring a weight of the granular material contained therein, the one or more weighing instruments being operatively connected to a respective local control unit and/or to the central control unit,
wherein each local control unit directly or indirectly transmits information to the central control unit on the weight of the material inside the respective container and causes the central control unit to control the quantity of the material by starting a filling cycle for increasing a quantity of the material inside the respective container by an amount determined by a control algorithm.

2. The control system of claim 1, wherein each local control unit, directly or indirectly, transmits information to the central control unit on a fill or empty status of the respective and/or other container and, directly or indirectly, causes the central control unit to start or stop the filling cycle of the respective and/or of the other container under specific conditions.

3. The control system of claim 1, further comprising one or more timers adapted to measure a duration of a refilling procedure of each of the containers and to determine and provide information, together with the one or more weighing instruments, on an inbound and/or outbound material flow rate for each of the containers.

4. The control system of claim 1, further comprising one or more devices determining one or more of an average duration for completing the filling cycle of the respective container, an average duration of prior filling cycles, an average inbound and/or outbound flow rate of the granular material, or an average historical consumption of the granular material between two or more filling cycles of the respective container.

5. The control system of claim 1, wherein the respective control unit or the central control unit is configured to allow one or more operating conditions of the respective container to be set to an arbitrary level and to be recorded for the respective container, and wherein the level of the granular material contained in the respective container is set to range up to a maximum accepted amount, causing the filling cycle of the respective container to be stopped when the arbitrary level is reached.

6. The control system of claim 1, wherein the central control unit or the respective local control unit is configured to extend the filling cycle of the respective container by an extra time if the respective container is not filled to a set level within a predetermined period of time, and wherein the central control unit or the respective local control unit ends the extended filling cycle either when the set level is achieved or the extra time expires.

7. The control system of claim 1, wherein in case two or more containers must be filled simultaneously, the central unit or the one or more of the local control units are adapted to provide priority to the filling cycle of the container with a statistically higher outbound flow rate using a different logic than a previously used logic.

8. The control system of claim 1, wherein the central control unit or the one or more of the local control units are adapted to reduce fill weight of each container as a function of an effective outbound average flow rate of said container, thereby reducing retention time of the amount of the granular material inside said container and maintaining proper temperature and/or degree of humidity of the granular material.

9. The control system of claim 1, further comprising temperature and/or humidity sensors installed in appropriate positions in each container and adapted to detect a possible degradation of the granular material inside said container, the possible degradation comprising one or more of an excessive cooling or a reabsorption of humidity, the temperature and/or humidity sensors being further adapted to reduce fill weight for said container by reducing retention time of that amount of the granular material inside said container, thereby maintaining a desired temperature and degree of humidity of the granular material.

10. A control system for a pneumatic transport system of a granular material, the pneumatic transport system including a plurality of containers, the control system comprising:
a plurality of local control units each operatively coupled to a respective container;
a central control unit operatively coupled to the plurality of local control units, wherein the central control unit or one or more of the local control units exchange information and issue operating commands to at least one of the local control units, wherein the information comprises control or operating information including instructions which cause the at least one of the local control units to answer by providing information in return and/or by starting one or more procedures at a local level; and
a wireless communication network operatively connecting the central control unit with the local control units through a wireless communication interface,
wherein said local control units, directly or indirectly, supply the information to the central control unit and/or execute the operating commands received from said central control unit through said wireless communication network.

11. The control system of claim 10, further comprising one or more weighing instruments operatively coupled to the respective container and measuring a weight of the granular material contained therein, the one or more weighing instruments being operatively connected to a respective local control unit or to the central control unit,
wherein each local control unit directly or indirectly transmits information to the central control unit on the weight of the granular material inside the respective container and causes the central control unit to control a quantity of the granular material by starting a filling cycle for increasing the quantity of the granular material inside the container by an amount determined by a control algorithm.

12. The control system of claim 11, wherein each local control unit, directly or indirectly, transmits information to the central control unit on a fill or empty status of the respective and/or other container and, directly or indirectly, causes the central control unit to start or stop the filling cycle of the respective and/or of the other container under specific conditions.

13. The control system of claim 11, further comprising one or more timers adapted to measure the duration of a refilling procedure of each of the containers and to determine and provide information, together with the one or more weighing instruments, on an inbound and/or outbound material flow rate for each of the containers.

14. The control system of claim 11, further comprising one or more devices adapted to determine one or more of an average duration for completing the filling cycle, an average duration of prior filling cycles, an average inbound and/or outbound flow rate of the granular material, or an average historical consumption of the granular material between two or more filling cycles of the respective container.

15. The control system of claim 11, wherein the respective control unit or the central control unit is configured to allow one or more operating conditions of the respective container to be set to an arbitrary level and to be recorded, and wherein a level of the granular material contained in the respective container ranges up to a maximum accepted amount such that filling cycle of said respective container is stopped when said arbitrary level is reached.

16. The control system of claim 11, wherein the central control unit or said local control unit is configured to extend the filling cycle of the respective container by an extra time if the respective container is not filled to a set level within a predetermined period of time, and wherein the central control unit or the respective local control unit ends the extended filling cycle either when the set level is achieved or the extra time expires.

17. The control system of claim 11, wherein in case two or more containers must be filled simultaneously, the central unit or the one or more control units are adapted priority to provide priority to the filling cycle of the container with a statistically higher outbound flow rate by using a different logic than a previously used logic.

18. The control system of claim 11, wherein the central control unit or the one or more of the local control units are adapted to reduce fill weight of each container as a function of an effective outbound average flow rate of said container, thereby reducing retention time of that amount of the granular material inside said container and maintaining proper temperature and/or degree of humidity of the granular material.

19. The control system of claim 11, further comprising temperature and/or humidity sensors installed in appropriate positions in each container and adapted to detect a possible degradation of the granular material inside said container, the possible degradation comprising one or more of the excessive cooling or the reabsorption of humidity, the temperature and/or humidity sensors being further adapted to reduce the fill weight for each container, by reducing the retention time of that amount of material inside said container, thereby maintaining a desired temperature and degree of humidity of the granular material.

20. The control system of claim 10, wherein the central control unit or one or more of said local control units configure interconnection topology of nodes of the wireless communication network dynamically such to provide the most efficient interconnection between transmitters and receivers that are coupled to the plurality of containers and to allow each node of the network to communicate with any other node without an a priori definition of the interconnection topology between the nodes.

21. The control system of claim 10, wherein the wireless communication network is provided with a network protocol that automatically assigns a unique address to each device connected to the wireless communication network.

22. The control system of claim 10, wherein one or more of the local control unit comprises a network processor implementing a communication protocol for the wireless communication network such to exchange data and information with any other node of the wireless communication network without burdening the respective local control unit with control and management of the wireless communication network.

23. The control system of claim 10, wherein the control system is configured to operate when one or more nodes of said wireless communication network are not functioning due to a temporary or permanent failure or due to maintenance operations of one or more containers by implementing a self-healing function for said wireless network without manual intervention that defines a new network configuration which excludes the one or more non-functioning nodes and maintaining all the other functioning nodes.

24. The control system of claim 10, further comprising portable, palm-sized, mobile, or similarly sized devices equipped with a wireless network interface and configured to supervise, program, and/or collect data, and wherein the portable, palm-sized, mobile, or similarly sized devices are integrated in said wireless communication network, thereby enabling an operator to access said wireless communication network to collect and configure containers or nodes belonging to said wireless communication network that are located not only in a close vicinity of the operator but also in remote positions from the operator.
